(19) United States
(12) Patent Application Publication
(10) Pub. No.: US 2005/0115800 A1
(43) Pub. Date: Jun. 2, 2005

(54) Method for adjusting barrel supports and barrel

(75) Inventors: Pascal Dromard, Montlebon (FR); Claudio Mathez, La Chaux-de-Fonds (CH)

Correspondence Address: PEARNE & GORDON LLP, 1801 EAST 9TH STREET, SUITE 1200, CLEVELAND, OH, 44114-3108, US

(73) Assignee: Ismeca Semiconductor Holding SA, La Chaux-de-Fonds (CH)

(21) Appl. No.: 11/003,666

(22) Filed: Dec. 3, 2004

Related U.S. Application Data
(63) Continuation of application No. PCT/CH03/00321, filed on May 19, 2003.

(30) Foreign Application Priority Data
Jun. 14, 2002 (CH) 2002CH-1014

(51) Int. Cl. F41A 1/00; B65G 47/24

(52) U.S. Cl. 198/394; 198/441

(57) ABSTRACT

Method for adjusting the supports for component-holders on a barrel for conveyors of electronic components that makes it possible to compensate and even totally correct the errors or inaccuracies that may have occurred during previous stages of the conveyor's manufacture thanks to an individual adjustment of each component-holder support's position relative to a reference position.

### REFERENCE DATA

This application is a continuation of PCT application PCT/CH03/00321 (WO03107731) filed on May 19, 2003, under priority of Swiss patent application 2002CH-1014 filed on Jun. 14, 2002, the contents whereof are hereby incorporated.

### FIELD OF THE INVENTION

The present invention concerns a method for adjusting the supports for component-holders of a barrel for conveyors of electronic components, as well as a barrel for executing the method.

### DESCRIPTION OF RELATED ART

During their manufacture, their conditioning or before being integrated onto a printed circuit, electronic components generally undergo a series of operations, for example electric tests, along a production line that is often entirely automated. The electronic components are thus transferred from one processing station to another by a conveyor, which can be for example linear or circular.

A barrel is the central element of a circular conveyor, around which several regularly spaced locations for processing stations are defined. Each of these locations is generally occupied by a processing station effecting one or several operations on the electronic components that are presented to it. In certain cases, one processing station can occupy several locations. The entire set of processing stations placed around the barrel thus forms a cycle of successive operations, for example electric or mechanical tests, conditioning operations etc., to which the electronic components conveyed on the barrel are subjected. The first processing station of the cycle is generally an entry station whose function consists essentially in bringing the electronic components, from a storage tank or from another conveyor, onto the barrel. The cycle can comprise one or several exit stations, thus allowing the components to be removed at various stages of the cycle, for example according to characteristics measured on a previous testing station.

With reference to FIGS. 1 and 2, the barrel 9 is equipped with supports for component-holders, generally bushings 4, into which are inserted the component-holders 5 serving to remove or receive the electronic components from the different processing stations, to hold them during the barrels' movement and, if necessary, to present them to the following processing station. The bushings 4 are regularly spread on the barrel 9, on a circle close to its periphery, along a disposition corresponding to that of the locations defined around the barrel 9. During a 360° rotation around its center, the barrel 9 thus has a finite number of steps at which each bushing 4 finds itself opposite a location for a processing station. The barrel 9 and the processing stations are generally united onto a same base plate 1, thus ensuring that their relative positions are maintained.

The barrel 9 is often mounted directly onto a rotary engine 10 fastened onto the base plate 1. The barrel 9 is rotated around its center by the engine 10 in short and rapid rotational movements followed by stopping moments at each step.

Before each rotational movement, the component-holders 5 inserted in their supports 4 take or receive the component that is on the processing station opposite. The barrel's position is then indexed by one step. During the barrel's movement, the components taken by the component-holders 5 are held by the latter onto the barrel 9. After the barrel's position has been indexed, each component-holder 5 arrives opposite the following location, which is generally equipped with the next processing station of the cycle. The component is then made available to the processing station that effects the operation for which it was designed. During the processing stage, the barrel is generally immobilized. The steps described here above are repeated, the conveyor thus transferring successively each component from one processing station to the next, until all the components to be processed have undergone a cycle of operations.

In most cases, the barrel's component-holders 5 comprise a nozzle 51 taking and holding the electronic components through air-vacuum. Other systems are however possible, for example mechanical grasping systems, for example pincers, or receptacles onto which the components are placed by each processing station and from which they are taken by the following processing station. Whatever the type of chosen component-holder, they are installed onto the barrel 9 after the latter has been completely manufactured, generally on component-holder supports, for example bushings 4, themselves fastened to the barrel 9 in adapted profiles 91. In most of the prior art systems, the bushings are driven into holes made at the barrel's periphery.

In the example illustrated by FIGS. 1 and 2, the component-holders 5 have an elongated cylindrical part 50 that is inserted into the corresponding bushing 4. To facilitate the insertion of the component-holder and to ensure its good retention in the bushing, a system of ball bearings 41 is slipped between the bushing 4 and the component-holder 5. The position of the component-holder 5 in the axis of the bushing 4 is adjusted so that the nozzle is at the desired height. A ring 7 is then slipped around the cylindrical part 50 of the component-holder 5 until it abuts against the bushing 4. The ring 7 comprises a pin 71 that is inserted into an auxiliary hole 92, thus preventing any undesirable rotation of the component-holder 5 in the bushing 4 after the ring 7 has been tightened around the cylindrical part 50 of the component-holder 5. The bushing 4, the component-holder 5, its blocking elements 7, 71 and their interaction with the profiles of the barrels 91 and 92 are detailed here above by way of example. Conveyors of electronic components can rely on highly diverse mechanisms for fastening the component-holders to the barrel 9.

The continuous evolution of then technology in the field of semi-conductors leads to a general reduction of the electronic components' size, thus requiring a higher accuracy of the systems for processing these components, as well as a miniaturization of the handling elements of these systems.

In the case of a barrel, this implies, beyond an accurate control of the step by step movements of the barrel and a reduction, for example, of the size of the component-holders' nozzles, an always greater accuracy in the manufacture of the different parts of the system and in the adjusting of their relative positions.

In the prior art systems, the profiles designed to receive the component-holder supports, for example the holes into which the bushings will be driven, are made during the barrel's manufacture. On the accuracy of their location and of their size will greatly depend the accuracy, in the finished system, of the alignment of the support, and consequently of the component-holder, with the locations of the processing stations defined around the barrel. The system's assembly generally begins by centering and fastening the barrel onto the engine, itself previously centered on the base plate, relative to the locations defined around it. The processing stations are then fastened onto the base plate, in the most accurate position possible relative to the barrel's position.

Such a system has considerable limitations as regards the assembly accuracy. Indeed, a slight error in the centering of the barrel can lead to considerable inaccuracies in the positioning of the bushings, and thus of the component-holders, relative to the processing stations. Known error computation methods teach in particular that the total error in the bushings' position relative to the locations of the processing stations is equal to the addition of the errors at each manufacturing or assembly stage, that is the error in the centering and in the dimensions of the profiles designed to receive the component-holder supports during the barrel's manufacture, the error in the centering of the engine on the base plate, the error in the centering of the barrel onto the engine, the error in the dimensions of the component-holder support and the error in the positioning onto the profile designed to receive it. Furthermore, such a system does not allow the correction of an error on the location or the dimensions of a single profile that might have occurred for example during the barrel's manufacture.

One aim of the invention is thus to propose an adjustment method allowing a significant increase in the aligning accuracy of the barrel's component-holders relative to the processing stations.

### BRIEF SUMMARY OF THE INVENTION

This aim is achieved by a method and a barrel having the characteristics of the corresponding independent claim, variant embodiments being described by the dependent claims.

In particular, this aim is achieved by a method for adjusting the position of the supports for component-holders on a barrel, said method comprising:
1) adjusting the position of a component-holder support on the barrel in a reference position,
2) blocking the support in this position.

### BRIEF DESCRIPTION OF THE DRAWINGS

The present invention will be better understood with the aid of the description of a preferred embodiment given by way of example, illustrated by the FIGS. 1 to 5.

FIG. 1, previously detailed, illustrates a circular conveying system comprising a barrel.

FIG. 2, previously detailed, illustrates an example of component-holder.

FIG. 3 shows a barrel and its position relative to the calibrating station used in a preferred embodiment of the invention.

FIG. 4 shows the calibrating station used in a preferred embodiment of the invention and its interaction with the component-holder support that is to be adjusted.

FIG. 5 shows a portion of the periphery of a barrel adapted to the execution of another preferred embodiment of the invention.

FIG. 6 shows a cross-section of one of the fingers of FIG. 5.

### DETAILED DESCRIPTION OF THE INVENTION

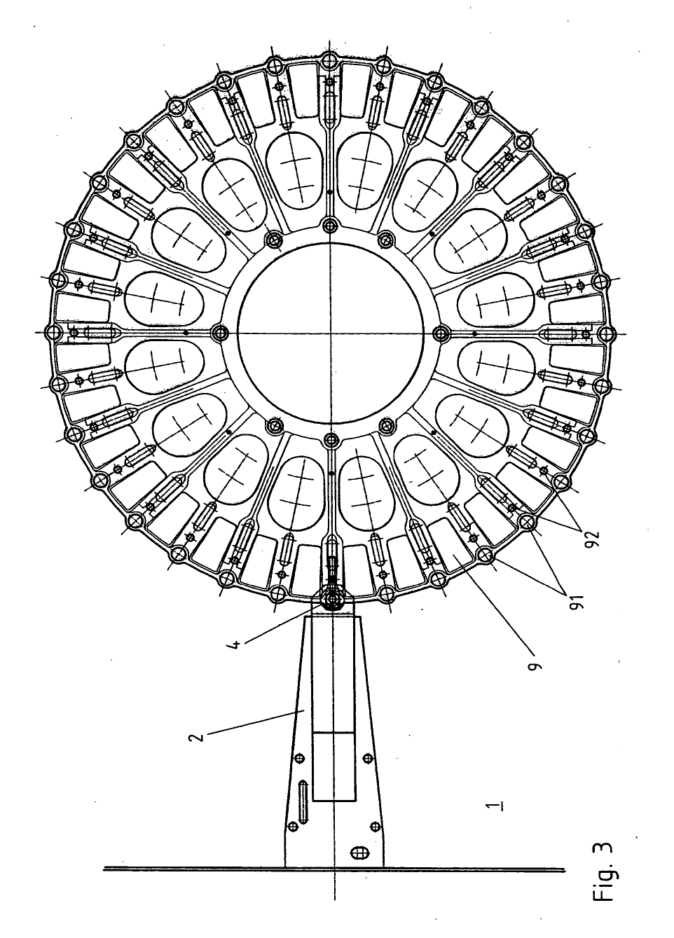

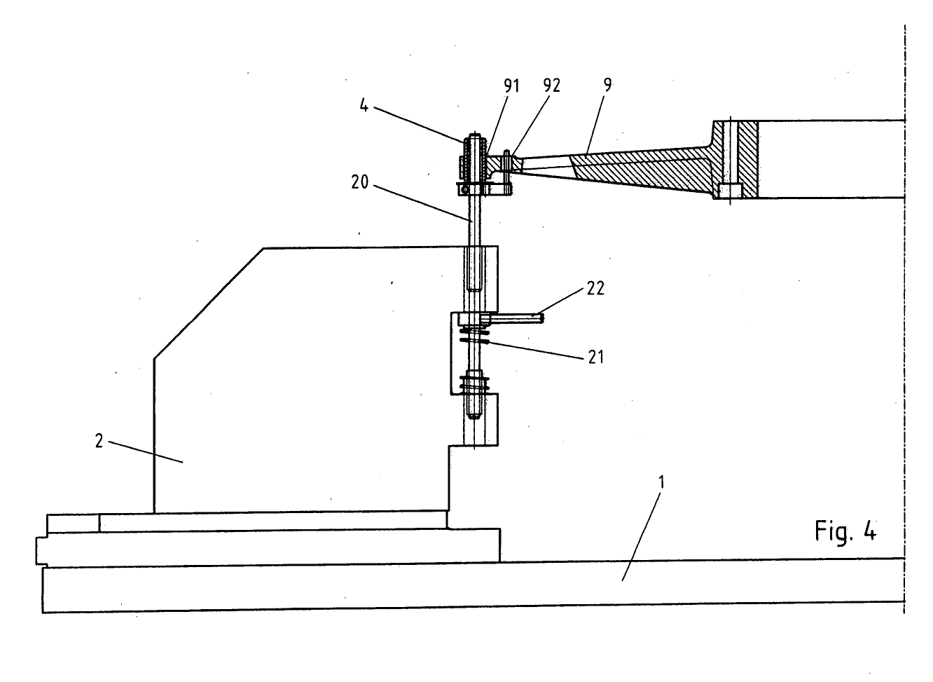

In its preferred embodiment, whose main elements are illustrated in FIGS. 3 and 4, the present invention is applied to a barrel 9 whose component-holder supports are bushings 4 fastened in holes 91 spread regularly on a circle close to the periphery of the barrel 9. During assembly of the system, the barrel 9 is fastened in rotation on a base plate 1. Before being completely fastened, its position is adjusted so that it is as centered as possible relative to the locations designed on the base plate for the processing stations. At least one of these locations is temporarily occupied by a calibrating station 2 defining a reference position for adjusting the position of the bushings 4.

In its preferred embodiment, the calibrating station 2 used for executing this preferred embodiment of the inventive method is held by its base, preferably screwed, onto the base plate 1. It comprises a calibrated rod 20 of a diameter close to the insider diameter of the bushings 4. The calibrated rod 20 is held upwards under the action of a spring 21, in the axis along which the bushings 4 will have to be oriented, generally vertically relative to the base plate 1. The reference rod 20 can be pulled downwards with the aid of a pin 22.

The barrel 9 is oriented so that a first hole 91 is positioned over the reference rod 20 whilst the latter is held downwards. The reference rod 20 is raised into the hole 91 and a bushing 4 is slid along the reference rod 20 inside the hole 91. On the reference rod, a ring similar to the rings 7 used for blocking the component-holders 5 is fastened, thus making it possible to determine accurately the position, on the axis of the reference rod, of the bushing 4 to be adjusted. The diameter of the hole 91 is considerably greater than the outer diameter of the bushing 4 in order to give the latter a certain play enabling thus its position to be adjusted. The rotation of the barrel 9 can be slightly corrected to center as much as possible the hole 91 around the bushing 4 held by the reference rod 20. The barrel's position after correction is preferably registered by the engine's control system as reference position of the indexing system. A hardening material, for example glue, mastic, resin etc., is then poured into the space between the hole 91 and the bushing 4 so that, when it hardens, the bushing 4 is fastened to the barrel 9.

Once the hardening material is sufficiently hard for the bushing 4 to be firmly held in position, the reference rod 20 is then lowered by means of the pin 22. The engine 10 is activated in order to turn the barrel 9 of a certain number of steps, until a new hole 91 is positioned over the reference rod 20. The reference rod 20 is raised and inserted into the hole 91. A bushing 4 is slid along the reference rod 20 into the hole 91 and liquid hardening material is poured in the space between the hole 91 and the bushing 4. When the hardening material is sufficiently hard, the reference rod 20 is again withdrawn from the bushing 4 to allow the movement of the barrel 9 until a new hole 91 is presented opposite the calibrating station 2.

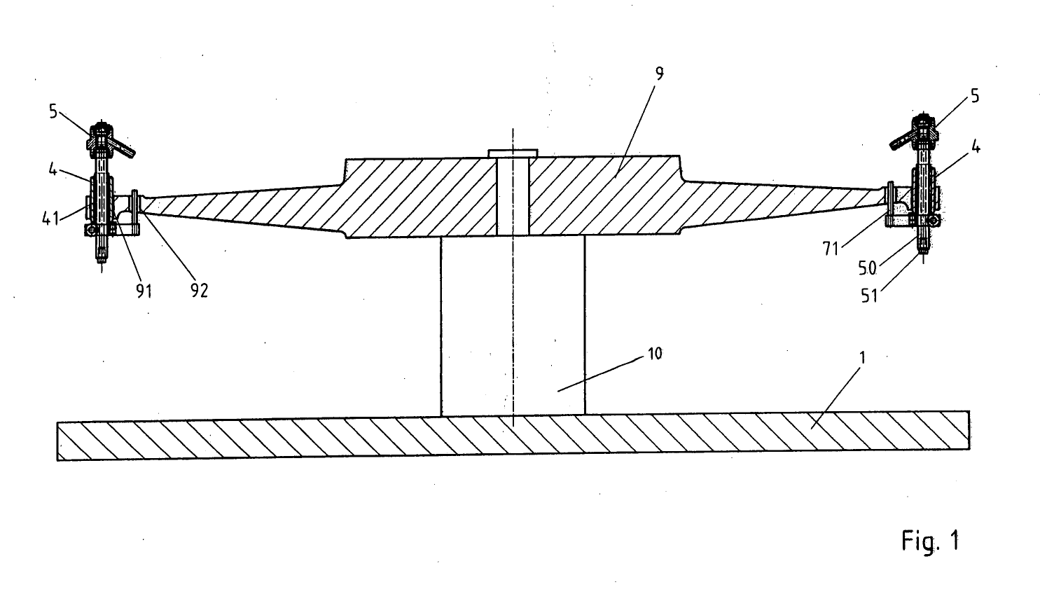

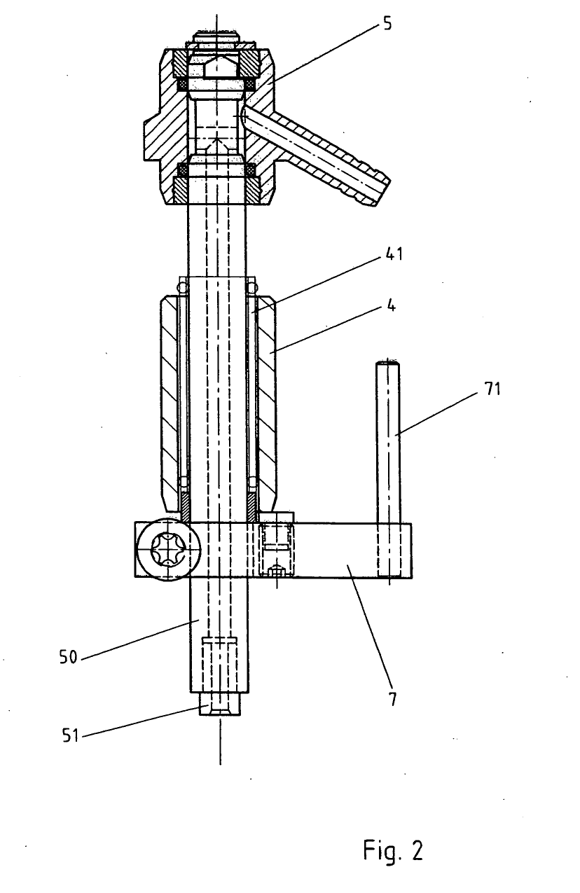

The adjusting stages described here above are repeated until each bushing 4 has been individually adjusted in each hole 91 of the barrel 9. Once all the bushings 4 have been individually adjusted and fastened onto the barrel 9, the component-holders 5 can be placed onto the barrel, for example according to the principle described above and illustrated by FIGS. 1 and 2.

Thanks to the method according to the invention, the position of each bushing 4 is thus individually adjusted relative to a reference position corresponding to the future position of the receiving and/or exit elements of the processing stations that will be installed around the barrel 9. The possible error in the position of the bushing 4 is thus determined only by the possible error during the adjusting of this position relative to the calibrating station 2. Such a method thus allows the errors or inaccuracies occurring during preceding stages, for example during the barrel's centering or during the machining of the holes 91 in the barrel 9 etc. to be compensated, or even totally corrected.

Each processing station installed around the barrel 9 is then individually positioned with accuracy so as to align its component receiving and/or exit elements of the components with the position of the component-holders 5. In the finished system, the accuracy of the alignment between the component-holders 5 and the processing stations thus depends only on the accuracy with which the bushings 4 are adjusted and on the accuracy with which each processing station is aligned.

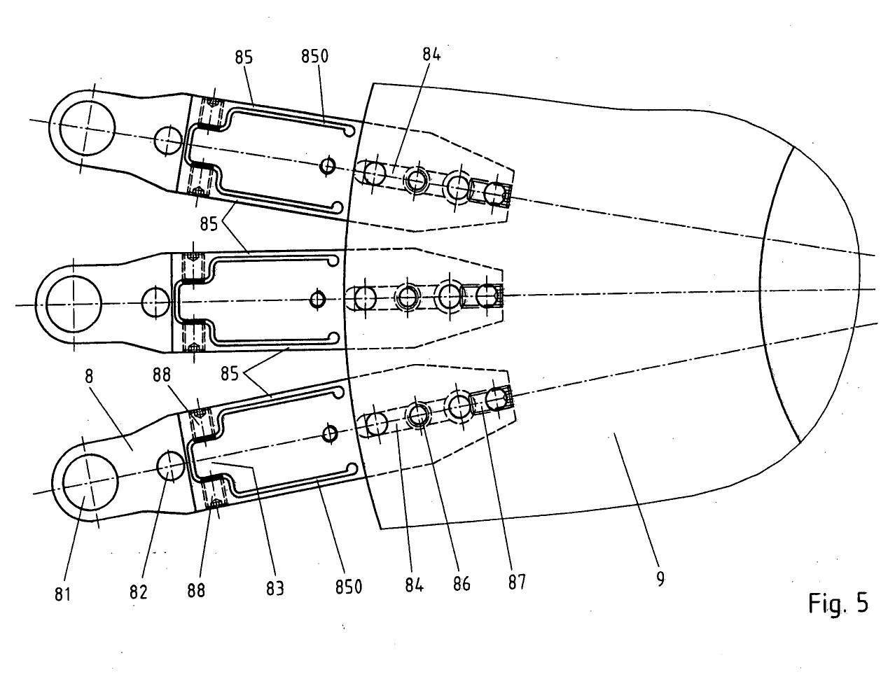

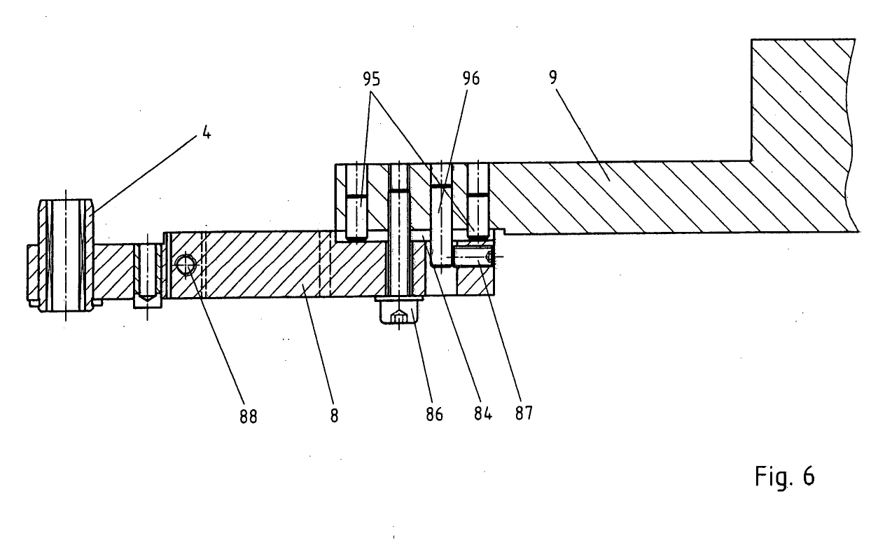

According to another preferred embodiment, the inventive method is applied to a barrel 9, illustrated by FIGS. 5 and 6, comprising adjustable fingers 8 spread regularly on its periphery and designed to receive the component-holder supports. The component-holder supports, which are in this case the bushings 4, are driven in holes 81, without any possibility to adjust their position relative to the adjustable finger 8. Preferably, each adjustable finger 8 comprises only a single bushing 4.

The adjustable finger 8 is fastened to the barrel 9 by a screw 86. Pins 95 are slid through openings provided for this purpose on the barrel 9 and one of their extremities is slid into a guide 84 provided on the side of the adjustable finger 8 oriented towards the barrel 9, thus holding the latter in a position more or less radial relative to the center of the barrel 9. An additional pin 96 is driven in a hole traversing the barrel 9 and serves as bearing for the radial adjusting screw 87 whose function will be described further below. The adjustable finger 8 comprises a notch 850 whose shape defines a rigid profile 83 and two flexible blades 85. The position of the rigid profile is fixed relative to the part of the adjustable finger 8 fastened to the barrel 9. The flexible blades 85 on the other hand allow the extremity of the adjustable finger 8 on which the bushing 4 is located to move relative to the rigid part 83 under the action of tangential adjusting screws 88.

During assembly of the system, the barrel 9 equipped with its adjustable fingers 8 is preferably fastened in rotation on the engine 10 previously fastened to the base plate 1 and is centered on the latter relative to the locations designed for the processing stations.

A calibrating station, not represented, is installed on one of the processing station locations. The calibrating station is preferably an optical system comprising a camera aiming accurately into the axis along which the bushings 4 are to be centered. The camera's signal is visualized on a control display and is superimposed over a test chart determining precisely the image's center. The superimposition, on the control display, of the image of the bushing 4 filmed by the camera and of the test chart thus allows the alignment of the bushing 4 relative to the reference axis to be determined.

In another variant of the method, the calibrating station not represented comprises two mechanical comparators oriented perpendicularly to each other and perpendicularly to the reference axis with respect to which the bushing 4 must be centered. In a reference position, the comparators are brought into contact for example with the outer surface of the bushing 4 to be adjusted or with the outer surface of a calibrated pin inserted in the bushing 4. Any deviation of this surface's position along the comparators' axes relative to a reference position can thus be measured accurately, allowing the adjustment of the bushing 4 with respect to the reference axis to be controlled perfectly.

The one skilled in the art will understand that, apart from the two aforementioned methods given by way of example, it could perfectly well be conceivable to use other methods for determining the centering of the bushing with respect to the reference axis.

In order to adjust the position of the bushing 4 in the radial direction relative to the center of the barrel 9, the screw 86 is slightly unscrewed, then the radial adjusting screw 87 is turned either clockwise to move the adjustable finger 8, and thus the bushing 4, away from the center of the barrel 9, or counter-clockwise to allow it to move closer to the center of the barrel 9. The radial position of the adjustable finger 8 is thus adjusted until the center of the bushing 4 is at the desired distance relative to the center of the barrel 9. The fastening screw 86 is then blocked in order to hold the adjustable finger 8 in the adjusted position.

The position of the bushing 4 along the tangent direction to the barrel 9 is adjusted thanks to the tangential adjusting screws 88 in the center of the notch 850. By modifying the relative pressure of the two tangential adjusting screws 88 on the rigid profile 83, the position of the adjustable finger 8, and consequently the position of the bushing 4, is modified thanks to the flexion of the blades 85.

Once the bushing 4 is centered on the reference axis determined by the calibrating station, the engine 10 is activated in order to make the barrel 9 turn by a certain number of steps until a new adjustable finger 8 to be adjusted is brought opposite the calibrating station. The adjustment stages described here above are then repeated until all the adjustable fingers 8 of the barrel 9 have been adjusted. Once the position of all the bushings 4 has been individually adjusted and blocked on the barrel 9, the component-holders 5 can be fastened on the barrel 9, for example according to the principle described above and illustrated by FIGS. 1 and 2.

Thanks to the inventive method, the position of each bushing 4 is thus individually adjusted relative to a reference position corresponding to the future position of the receiving and/or exit elements of the processing stations that will be installed around the barrel 9. The possible error in the position of the bushing 4 is thus uniquely determined by the possible error in adjusting this position relative to the calibrating station 2. Such a method thus makes it possible to compensate and even totally correct the errors or inaccuracies that may have occurred during previous stages, for example during the centering of the barrel or during the machining of the holes 81 in the adjustable fingers 8, etc.

Although the aforementioned adjusting means of the adjustable finger 8 have been conceived for adjusting the position of the bushing 4 along two axes in a horizontal plane relative to the base plate 1, the one skilled in the art will understand that it can easily be conceived to complete or modify these adjusting means in order for example to be able also to adjust the bushing's position in a vertical plane or along any other axis.

Each processing station installed around the barrel is then individually positioned with precision so as to align its receiving and/or exit elements with the position of the component-holders. In the finished system, the accuracy of the alignment between the component-holders and the processing stations thus depends only on the accuracy with which the bushings 4 are adjusted and on the accuracy with which each processing station is aligned.

The inventive method, detailed here above for two preferred embodiments given by way of illustrative but by no means limiting example, makes it possible, thanks to the individual adjustment of each component-holder support relative to a unique reference position, to compensate the errors or inaccuracies that may have occurred during preceding stages in the manufacturing or assembly of the system, for example inaccuracies during the machining of the profiles designed to receive the component-holder supports, errors in the barrel's centering relative to the locations designed for the processing stations, etc.

Although in the preferred embodiments of the inventive method described here above the adjusting of each component-holder support is performed individually, the one skilled in the art will understand that it is also possible to use the inventive method for adjusting simultaneously the position of several component-holder supports, for example through simultaneous use of several calibrating stations, through use of calibrating stations comprising several reference positions corresponding to the positions of several bushings to be adjusted, contiguous or not, etc. Despite the reduction in the time required for adjusting all the component-holder supports of the barrel, this variant of the inventive method however has more possibilities of inaccuracies in the adjustment, notably through possible errors in the relative positions of the different reference positions.

It is also possible for the one skilled in the art to apply the method according to the invention and to adapt the adjusting means for adjusting the position of the component-holder supports on the barrel along other axes than those mentioned in the above examples, for example along a vertical axis relative to the base plate 1 or along a rotational axis, for example vertical or horizontal.

1. A method for adjusting the position of component-holder supports on a barrel for a conveyor of electronic components, said method comprising:
1) adjusting the position of at least one of said component-holder supports on said barrel in a determined reference position,
2) blocking said at least one of said component-holder supports in said reference position.

2. The method of claim 1, said barrel being previously fastened in rotation on a base plate through the intermediary of a base.

3. The method of claim 1, comprising subsequently
3) rotating said barrel by a finite number of fractions of a complete turn,
4) adjusting the position of at least one other of said component-holder supports on said barrel in a determined reference position,
5) blocking said at least one other of said component-holder supports in said reference position,
6) repeating points 3), 4) and 5) until all said component-holder supports have been adjusted and blocked.

4. The method of claim 1, said reference position being determined through mechanical means.

5. The method of claim 4, said mechanical means being a reference rod.

6. The method of claim 4, said mechanical means being comparators.

7. The method of claim 1, said reference position being determined through optical means.

8. The method of claim 1, said at least one of said component-holder supports being blocked in said reference position by means of a hardening material.

9. The method of claim 1, said at least one of said component-holder supports being blocked in said reference position through mechanical adjusting means.

10. The method of claim 1, the reference positions of plurality of component-holder supports being determined simultaneously.

11. A barrel for a conveyor of electronic components, comprising on its periphery component-holder supports, characterized in that the position of each of said component-holder supports can be adjusted individually during assembly of the conveyor without machining said barrel.

12. The barrel of claim 11, said component-holder supports being bushings.

13. The barrel of claim 11, the position of each of said component-holder supports being adjustable through mechanical adjusting means.

14. The barrel of claim 13, the mechanical adjusting means comprising adjusting screws.

15. The barrel of claim 11, said component-holder supports being glued to the barrel.

16. The barrel of claim 11, said component-holder supports being spread on adjustable fingers fastened at the periphery of said barrel.

17. The barrel of claim 16, said adjustable fingers comprising a notch allowing the flexion of said adjustable fingers along at least one axis.

18. The barrel of claim 11, said position of each of said component-holder supports being capable of being adjusted along at least two independent axes.

19. The barrel of claim 18, said position of each of said component-holder supports being capable of being adjusted along at least three independent axes.
